(19) United States
(12) Patent Application Publication
(10) Pub. No.: US 2018/0263834 A1
(43) Pub. Date: Sep. 20, 2018

(54) CONTROL SYSTEM FOR A BATHING AID, BATHING SYSTEM AND METHOD

(71) Applicant: Robotics Care AB, Djursholm (SE)

(72) Inventor: Thomas Ryberg, Djursholm (SE)

(73) Assignee: Robotics Care AB, Djursholm (SE)

(21) Appl. No.: 15/540,413

(22) PCT Filed: Nov. 27, 2015
(86) PCT No.: PCT/EP2015/077933

§ 371 Date: Jun. 28, 2017

(30) Foreign Application Priority Data
Dec. 29, 2014 (EP) 14200398.7

(51) Int. Cl. A61G 7/10; A47K 3/00

(52) U.S. Cl. CPC A61G 7/1003; A61G 2203/44; A61G 7/1059; A47K 3/001

(57) ABSTRACT

A control system (810) for a bathing aid (100), wherein the bathing aid comprises a bathing enclosure (101), a telescopic element (110), a seat (120) and an actuation system (140) coupled to the telescopic element and the seat. The actuation system is configured to move the seat on the telescopic element along the horizontal axis between a retracted position of the seat within the bathing enclosure and an extended position of the seat outside the bathing enclosure. The bathing aid further comprises a water supply system (710) for a supply of water to the bathing enclosure. The control system is configured for communicative coupling to the actuation system and to the water supply system, and wherein the control system is configured to control a movement of the seat and configured to control a supply of water to the bathing enclosure.

### FIELD OF THE INVENTION

This invention relates to a control system for a bathing aid, in particular for the purpose of assisting an elderly, disabled, injured and/or mobility-impaired person when bathing.

### BACKGROUND OF THE INVENTION

Bathing procedures are often problematic for elderly and/or disabled persons due to several reasons. Firstly, it should be noted that bathing arrangements such as showers and bathtubs are usually designed for the non-disabled, and especially entering and exiting these arrangements may be related to severe difficulties for disabled persons. Secondly, it will be appreciated that the bathroom environment itself may be potentially dangerous, e.g. when considering that bathroom floors may be hard and slippery. Hence, taking a shower or a bath may be hazardous for elderly and/or disabled persons, and may in some cases result in physical injuries. Consequently, many people may be forced to bathe less frequently to avoid the risks related thereto. Alternatively, help must be obtained of one or more assistants in the bathroom, especially when entering or exiting the shower or bathtub. However, the assisting staff may hereby be exposed to heavy and/or awkward lifting when helping the person, and the staff may hereby also run the risk of being injured. Furthermore, the need of assistance when undressing and/or taking care of one's personal hygiene may be embarrassing and/or humiliating for the bather.

In light of the above observations, there is an increasing need for an arrangement which is able to provide a safe and convenient assistance to elderly and/or disabled persons regarding shower or bath accessibility, and a convenient operation of such an arrangement.

US2011/0283449 describes a system and apparatus for assisting a person during entering and exiting a bathtub and shower. The system comprises a bathtub chair system having a support member having a first end coupled to the first side of the bathtub, extending across and beyond the second side of the bathtub to a base member at the second end of the support member. The system further comprises a seating surface disposed on the support member, an electric motor disposed within the base member and a drive member coupling the seating surface to the electric motor.

However, the system as described does not provide a convenient access of an elderly and/or disabled person to the bathtub, nor a convenient bathing procedure. Hence, alternative solutions are of interest, such that a safe, reliable and convenient assistance to elderly and/or disabled persons regarding shower or bath accessibility and procedure may be provided.

### SUMMARY OF THE INVENTION

It is an object of the present invention to mitigate the above problem, and to provide a system and a method which are able to achieve a safe and convenient control of the bath or shower access and procedure.

This and other objects are achieved by providing a control system and a method having the features defined in the independent claim. Preferred embodiments are defined in the dependent claims.

Hence, according to a first aspect of the present invention, there is provided a control system for a bathing aid. The bathing aid may comprise a bathing enclosure and a telescopic element arranged at least partially within the bathing enclosure, wherein the telescopic element may be extendable and retractable along a horizontal axis. The bathing aid may further comprise a seat for supporting a person, wherein the seat may be arranged on the telescopic element. The bathing aid may further comprise an actuation system coupled to the telescopic element and the seat. The actuation system may be configured to move the seat on the telescopic element along the horizontal axis between a retracted position of the seat within the bathing enclosure and an extended position of the seat outside the bathing enclosure. The bathing aid further may further comprise a water supply system for a supply of water to the bathing enclosure. The control system is configured for communicative coupling to an actuation system and to a water supply system of a bathing aid as described. The control system is further configured to control a movement of the seat and configured to control a supply of water to the bathing enclosure.

According to a second aspect of the present invention, there is provided a method of bathing a person in a bathing aid. The bathing aid comprises a bathing enclosure, a telescopic element arranged at least partially within the bathing enclosure, wherein the telescopic element is extendable and retractable along a horizontal axis. The bathing aid further comprises a seat for supporting a person, wherein the seat is arranged on the telescopic element, and an actuation system coupled to the telescopic element and the seat, wherein the actuation system is configured to move the seat on the telescopic element along the horizontal axis between a retracted position of the seat within the bathing enclosure and an extended position of the seat outside the bathing enclosure, and a water supply system for a supply of water to the bathing enclosure. The method comprises controlling a movement of the seat via the actuation system and controlling a supply of water to the bathing enclosure via the water supply system.

The control system for the bathing aid hereby provides a convenient assistance to persons regarding shower or bath accessibility, as well as a convenient shower or bathing procedure. The control system allows for a reliable and convenient control of the movement of the seat of the bathing aid, as well as a reliable and convenient control of the water supply to the bathing enclosure. It will be appreciated that the control system hereby may provide a bathing procedure which is particularly suitable for elderly and/or disabled persons.

The control system is configured for communicative coupling to an actuation system as described. The control system may hereby, via the actuation system, control a movement of a seat of the bathing aid. The seat, which may be arranged on the telescopic element, may be movable by means of the actuation system back and forth between a retracted position of the seat within the bathing enclosure in which the person is showered, bathed and/or washed, and an extended position of the seat outside the bathing enclosure, in which the person sits up on the seat before the showering and/or bathing or leaves the seat after the showering and/or bathing. The control system is hereby configured to provide a convenient access of a person to the seat before his/her showering and/or bathing, and analogously, a convenient leaving of the seat of the person after the showering and/or bathing, as the control system is configured for communicative coupling to an actuation system as disclosed. Via the actuation system, the control system is configured to gently and conveniently transport a person from a position outside a bathing enclosure into the bathing enclosure of a bathing aid as disclosed, where the showering and/or bathing procedure takes place. After said procedure, the control system is configured to gently and conveniently transport the person back into the position outside the bathing enclosure via the actuation system. In an extended position of the seat outside the bathing enclosure, the control system may be configured to control a rotation of the seat in a horizontal plane via the actuation system. The control system for the bathing aid may hereby facilitate the action of the person to sit upon a seat, and leave the seat, respectively, in an easy and convenient manner. Furthermore, as the control system may be configured to control a tilting of the seat with respect to a vertical axis via the actuation system, the control system may even further facilitate the manner in which the person may sit upon the seat, and leave the seat, respectively.

The control system is further configured for communicative coupling to a water supply system of a bathing aid, and configured to control a supply of water to a bathing enclosure of a bathing aid. The control system is hereby configured to provide a control of the water supply when a person intends to shower and/or bathe by means of a bathing aid as described. It will be appreciated that the control system hereby provides a convenient shower or bathing procedure for a person intending to take a shower and/or a bath. The control system, which may be automatically and/or manually operated, may allow the person to control his/her shower or bathing procedure (e.g. amount of water, water distribution, water temperature, etc.). Alternatively, the control system may be configured to provide water according to a predetermined program.

An advantage of the present invention is that the control system may provide the ability of a person to shower and/or bathe in a safe, reliable and convenient manner. It will be appreciated that the control system for a bathing aid is configured for communicative coupling to the actuation system, which may encompass a controlled transportation of a person back and forth between a position outside a bathing enclosure and a position inside the bathing enclosure. Hence, the control system may support a person's bathing and/or shower procedure in that it may inhibit the occurrences of accidents when bathing and/or showering such as slipping and/or falling accidents. Hence, the control system may hereby be configured to safely, reliably and conveniently transport a person using a bathing aid as disclosed. The present invention may hereby provide a safe bathing and/or shower procedure, especially for elderly and/or disabled persons. Furthermore, as the control system is configured for communicative coupling to a water supply system of a bathing aid, the control system is hereby configured to control a provision of water to a bathing aid in a safe, reliable and convenient manner during a person's showering of bathing procedure. For example, the control system may be configured to control one or more of the properties of the water from the water supply system such as water temperature, amount of water, water distribution, etc. This leads to a shower and/or bathing procedure which is highly advantageous for elderly and/or disabled persons, as the control system may mitigate several risks that may occur when bathing. For example, the control system may mitigate that a person is burnt by high-temperature water, shocked by low-temperature water, or, in an extreme case, drowns due to a to large amount of water in the bathing enclosure.

Another advantage of the present invention is that a person may assist himself/herself when bathing and/or showering without the need of help from one or more assistants. This is understood as the control system for a bathing aid may be configured to transport a person between a position outside a bathing enclosure and a position inside a bathing enclosure, and back again, and wherein the control system furthermore may provide an easy and convenient access to and/or sitting on the seat as well as an easy and convenient rising from the seat for the person. Furthermore, the person may assist himself/herself during the actual shower or bathing procedure. This is understood as the control system for a bathing aid is configured to control the supply of water to the bathing enclosure, whereby the water supply may be controlled automatically or manually. Hence, by means of the control system of the present invention, the need of one or more assistants may be avoided, which is economically beneficial.

Another advantage of a person's ability to assist himself/herself when bathing and/or showering without the need of assistant help is that the risk of injures of assistant staff may hereby be avoided. It will be appreciated the control system of the present invention may counteract the risk of exposing assistant staff to heavy and/or awkward lifting when helping a person, as the control system provides a possibility for a person to bathe/shower autonomously.

It will be appreciated that the need of assistance when undressing and/or taking care of one's personal hygiene may be embarrassing and/or humiliating for the bather. Hence, another advantage of the present invention is that the control system may contribute to the intimacy of the bathing person, as no personal assistance may be needed for the person intending to take a bath and/or shower in a bathing aid for which the control system may be provided.

The bathing aid, for which the control system of the present invention may be provided, may comprise a bathing enclosure. By the term “bathing enclosure”, it is here meant substantially any (shower) cabin, cabinet, cubicle, booth, (bath) tub, or the like. The bathing aid may further comprise a telescopic element arranged at least partially within the bathing enclosure. By the term “telescopic element”, it is here meant an element which is able to become longer (extended) or shorter (retracted), e.g. by having sections that slide inside one another. The telescopic element is extendable and retractable along a substantially horizontal axis. The bathing aid may further comprise a seat for supporting a person, wherein the seat may be arranged on the telescopic element. By the term “seat”, it is here meant substantially any kind of element for supporting a person in a sitting position. The bathing aid may further comprise an actuation system coupled to the telescopic element and to the seat. By the term “actuation system”, it is here meant substantially any system, arrangement and/or device configured, arranged and/or adapted to actuate, drive, move and/or run any element(s) coupled thereto. The actuation system may be configured, arranged and/or adapted to move the seat on the telescopic element along the (substantially) horizontal axis between a retracted position of the seat within the bathing enclosure and an extended position of the seat outside the bathing enclosure, and back again. In other words, the actuation system may be configured to move the telescopic element upon which the seat is arranged. By the term “configured”, it is here meant that the actuation system is arranged, adapted and/or able to perform an action (e.g. a rotation and/or tilting of the seat), but is not forced to do so if not needed and/or desired. Furthermore, in the extended position of the seat, the control system, via the actuation system, may be configured, arranged, adapted and/or able to control a rotation of the seat in a (substantially) horizontal plane. It will be appreciated that the control system may hereby be configured to control a rotation of the seat in the horizontal plane if needed and/or desired by means of the actuation system. Furthermore, in the extended position of the seat, the control system may be configured, arranged, adapted and/or able to control a tilting of the seat with respect to a (substantially) vertical axis via the actuation system. It will be appreciated that the control system hereby may be configured to control a tilting of the seat with respect to the vertical axis if needed and/or desired by means of the actuation system. Hence, the control system may be configured to control a tilting of the seat with respect to the vertical axis via the actuation system, but is not forced to do so if not needed and/or desired.

The bathing aid may further comprise a water supply system. It will be appreciated that the water supply system may be substantially any system for supplying water to the bathing enclosure. For example, the water supply system may be arranged and/or formed as a shower system, e.g. comprising one or more (shower) nozzles. Alternatively, the water supply system may be arranged and/or formed as a bath system, e.g. comprising one or more taps to at least partially fill the bathing enclosure with water.

The control system is configured for communicative coupling to the actuation system and to the water supply system. By the term “communicative coupling”, it is here meant substantially any coupling and/or link (e.g. by wire or wireless) through which a communication may be established. Furthermore, the control system is configured to control a movement of the seat and configured to control a supply of water to the bathing enclosure. Hence, the control system may be configured both to control a transportation of a person into and out of a bathing enclosure of a bathing aid, and to control a provision of water to the bathing enclosure for the person's showering and/or bathing procedure.

According to an embodiment of the present invention, the control system may further comprise at least one control unit which is arrangeable on the seat and which is configured to be manually operable by a person sitting on the seat. By the term “arrangeable”, it is here meant that the control unit may be attached, provided and/or connected to/on a seat of a bathing aid. For example, the control unit may be arranged on an arm rest of the seat. By the term “control unit”, it is here meant substantially any unit, system, arrangement and/or device configured, arranged, adapted and/or able for control, e.g. based on feedback. The control unit for the bathing aid may be configured to control a movement of the seat via the actuation system and/or be configured to control a supply of water to the bathing enclosure via the water supply system. The present embodiment is advantageous in that the control unit may be easily and conveniently operated by a person sitting on a seat of a bathing aid.

According to an embodiment of the present invention, the water supply system may comprise at least one water nozzle arranged within the bathing enclosure and configured to spray water, wherein the control system may be configured to control the supply of water to the at least one water nozzle. The present embodiment is advantageous in that the control system may be configured to provide water to the water nozzle(s) in a controlled manner, either by manual operation (e.g. by a person sitting on a seat of a bathing aid) or automatically (e.g. according to a predetermined program).

According to an embodiment of the present invention, the control system may be configured to control a supply of water to the bathing enclosure according to a predetermined cleaning program. By the term “predetermined cleaning program”, it is here meant a program set in advance, e.g. for cleaning a person sitting on the seat of a bathing aid for which the control system may be provided and/or for cleaning the interior of the bathing enclosure of the bathing aid. For example, the program may include a water supply which is dependent on time, amount of water, position of one or more water nozzles, etc. In other words, there is provided a predetermined cleaning program according to (as a function of) which the control system is configured, arranged, adapted and/or able to control the supply of water to the bathing enclosure. The present embodiment is advantageous in that a person sitting on the seat within the bathing enclosure may take a shower and/or a bath without the need of any manual intervention. Alternatively, the control system may be manually operable by the person using and/or intending to use the bathing aid, or be operable by any other person, such as an assistant, on the outside of the bathing enclosure.

According to an embodiment of the present invention, the bathing aid may further comprise a product supply system for a supply of at least one cleaning product to the bathing enclosure, and wherein the control system is configured for communicative coupling to the product supply system and configured to control a supply of the at least one cleaning product to the bathing enclosure. It will be appreciated that the product supply system may be substantially any automatically and/or manually operated system for supplying at least one body cleaning product to the bathing enclosure. By the term “cleaning product”, it may be meant substantially any product for the purpose of cleaning and/or washing the human body, such as soap, shampoo, (hair) conditioner, etc. Alternatively, the term “cleaning product” may represent substantially any product, substance or agent used to remove dirt, dust, stains and/or body excrements (such as faeces, urine, sweat, etc.) on surfaces. The present embodiment is advantageous in that the control system is configured to easily and conveniently control the supply of the cleaning product to the bathing enclosure.

According to an embodiment of the present invention, the product supply system may comprises at least one cleaning product nozzle arranged within the bathing enclosure and configured to spray a cleaning product, wherein the control system is configured to control the supply of cleaning product to the at least one cleaning product nozzle. The present embodiment is advantageous in that the control system is configured to easily and conveniently control the supply of the cleaning product to the bathing enclosure. For example, the control system may be configured to control the supply of cleaning product to one or more cleaning product nozzles for cleaning a person sitting on the seat of the bathing aid for which the control system may be provided. The control system may alternatively be configured to control the supply of cleaning product to the bathing enclosure by means of cleaning product nozzle(s) for the purpose of cleaning the bathing enclosure interior before and/or after the bathing procedure.

According to an embodiment of the present invention, the control system may be configured to control a supply of cleaning product to the bathing enclosure according to a predetermined cleaning program. For example, the cleaning program may include a supply of cleaning product and/or agent which is dependent on time, amount of product, position of one or more cleaning product nozzles, etc. The present embodiment is advantageous in that a person sitting on the seat within the bathing enclosure may take a shower and/or a bath according to the predetermined program, i.e. without the need of any manual intervention. Alternatively, the control system may be configured to clean the interior of the bathing enclosure according to a cleaning program.

According to an embodiment of the present invention, there is provided a bathing system comprising a bathing aid. The bathing aid comprises a bathing enclosure and a telescopic element arranged at least partially within the bathing enclosure, wherein the telescopic element is extendable and retractable along a horizontal axis (x). The bathing aid further comprises a seat for supporting a person, the seat being arranged on the telescopic element. The bathing aid further comprises an actuation system coupled to the telescopic element and the seat, wherein the actuation system is configured to move the seat on the telescopic element along the horizontal axis between a retracted position of the seat within the bathing enclosure and an extended position of the seat outside the bathing enclosure. The bathing aid further comprises a water supply system for a supply of water to the bathing enclosure. The bathing system further comprises a control system according to any one of the preceding embodiments. The present embodiment is advantageous in that the bathing system provides a convenient assistance to persons regarding shower or bath accessibility, as well as a convenient shower or bathing procedure. The control system allows for a reliable and convenient control of the movement of the seat of the bathing aid of the bathing system, as well as a reliable and convenient control of the water supply to the bathing enclosure. It will be appreciated that the bathing system hereby provides a bathing procedure which is particularly suitable for elderly and/or disabled persons.

According to an embodiment of the present invention, the bathing system may further comprise at least one water nozzle arranged within the bathing enclosure and configured to spray water. The water nozzle(s) may be arranged at various positions within the bathing enclosure, e.g. for cleaning different areas of the person using the bathing aid and/or for the purpose of cleaning and/or washing an area within the bathing enclosure. The present embodiment is thereby advantageous in that the water from the water nozzle(s) may efficiently and conveniently clean a person sitting on the seat within the bathing enclosure at one or more areas of his/her body and/or clean an area in the bathing enclosure interior.

According to an embodiment of the present invention, the seat may comprise two separated parts arranged in parallel and defining a space between them, wherein at least one of the at least one water nozzle is configured to spray water through the space on a person sitting on the seat. The present embodiment is advantageous in that one or more water nozzles may be arranged to spray water through the seat space, e.g. towards a genital, perianal and/or intergluteal area of a person sitting on the seat. The present embodiment is particularly advantageous for washing/cleaning the lower abdomen of women, as water from the water nozzle(s) may be sprayed in a direction from the woman's vaginal area towards the perianal or intergluteal area.

According to an embodiment of the present invention, the seat may comprise two separated parts arranged in parallel and defining a space between them, wherein at least one of the at least one water nozzle may be configured to spray water in an area of the bathing enclosure under the space. The present embodiment is advantageous in that the seat which comprises a space between its parts may function as a toilet seat, whereby excrements such as faeces and/or urine may fall through the space of the seat when a person is sitting on the seat. The present embodiment is further advantageous in that one or more water nozzles may be configured to spray water in an area in which the excrements of the person are present, such that the area may be cleaned.

According to an embodiment of the present invention, the bathing system may further comprise a product supply system for a supply of at least one cleaning product to the bathing enclosure, and wherein the product supply system may comprise at least one cleaning product nozzle arranged within the bathing enclosure and configured to spray the cleaning product. The present embodiment is advantageous in that the cleaning product nozzle(s) may be arranged and/or configured to spray a cleaning product (e.g. soap) on a person sitting on the seat of the bathing aid for cleaning the person. Alternatively, the cleaning product nozzle(s) may be arranged and/or configured to spray a cleaning product (e.g. a detergent and/or cleaning agent) for the purpose of cleaning the bathing enclosure interior.

According to an embodiment of the present invention, the seat comprises two separated parts arranged in parallel and defining a space between them, wherein at least one of the at least one cleaning product nozzle is configured to spray the cleaning product through the space on a person sitting on the seat. The present embodiment is advantageous in that one or more cleaning product nozzles may be arranged to spray a cleaning product through the seat space, e.g. towards a genital, perianal and/or intergluteal area of a person sitting on the seat. The present embodiment is particularly advantageous for washing/cleaning the lower abdomen of women, as a cleaning product from the nozzle(s) may be sprayed in a direction from the woman's vaginal area towards the perianal or intergluteal area.

According to an embodiment of the present invention, the seat may comprise two separated parts arranged in parallel and defining a space between them, wherein at least one of the at least one cleaning product nozzle may be configured to spray a cleaning product in an area of the bathing enclosure under the space. The present embodiment is advantageous in that one or more cleaning product nozzles may be configured to spray a cleaning product into an area with the purpose of cleaning it, which may be particularly advantageous in case excrements are present in the area.

The control system according to any one of the previous embodiments may furthermore comprise at least one weight sensor arrangeable on the seat of the bathing aid for sensing the weight of a person sitting on the seat, wherein the control system may be configured to control a movement of the seat and configured to control a supply of water to the bathing enclosure as a function of the weight sensed by the at least one weight sensor. Alternatively, the seat of the bathing system may comprise at least one weight sensor arranged on the seat of the bathing aid for sensing the weight of a person sitting on the seat. The at least one weight sensor may be provided, arranged and/or distributed on and/or in the seat such that the weight sensor(s) may determine the distribution of the weight of the person on the seat. The control system may be configured to determine the position of the person on the seat, and may furthermore be configured to determine if a person sits correctly or incorrectly on the seat. The control system may hereby be configured to control a movement of the seat and/or be configured to control a supply of water to the bathing enclosure based on the distribution of the weight of the person on the seat. The weight sensor(s) of the control system contributes to an even safer and more convenient assistance to elderly and/or disabled persons regarding shower or bath accessibility, and an even more convenient shower and/or bathing procedure.

It will be appreciated that advantages of the first aspect of the present invention also hold for the second aspect of the present invention, and it is hereby referred to these portions of the text.

Further objectives of, features of, and advantages with the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects of the present invention will now be described in more detail, with references to the appended drawings showing embodiments of the invention.

FIG. 1a shows a schematic illustration of a bathing aid,

FIG. 1b shows a control system for a bathing aid according to the present invention,

FIG. 2 shows a schematic illustration of a control unit of a control system according to an embodiment of the present invention,

FIG. 3 shows a schematic illustration of a movement of the seat according to an embodiment of the present invention,

FIG. 4 shows a schematic illustration of a control system according to an embodiment of the present invention,

FIG. 5 shows a schematic illustration of a bathing system according to an embodiment of the present invention, and

FIG. 6 shows a schematic illustration of a control system according to an example of the present invention,

All the figures are schematic, not necessarily to scale, and generally only show parts which are necessary in order to elucidate the invention, wherein other parts may be omitted or merely suggested.

### DETAILED DESCRIPTION

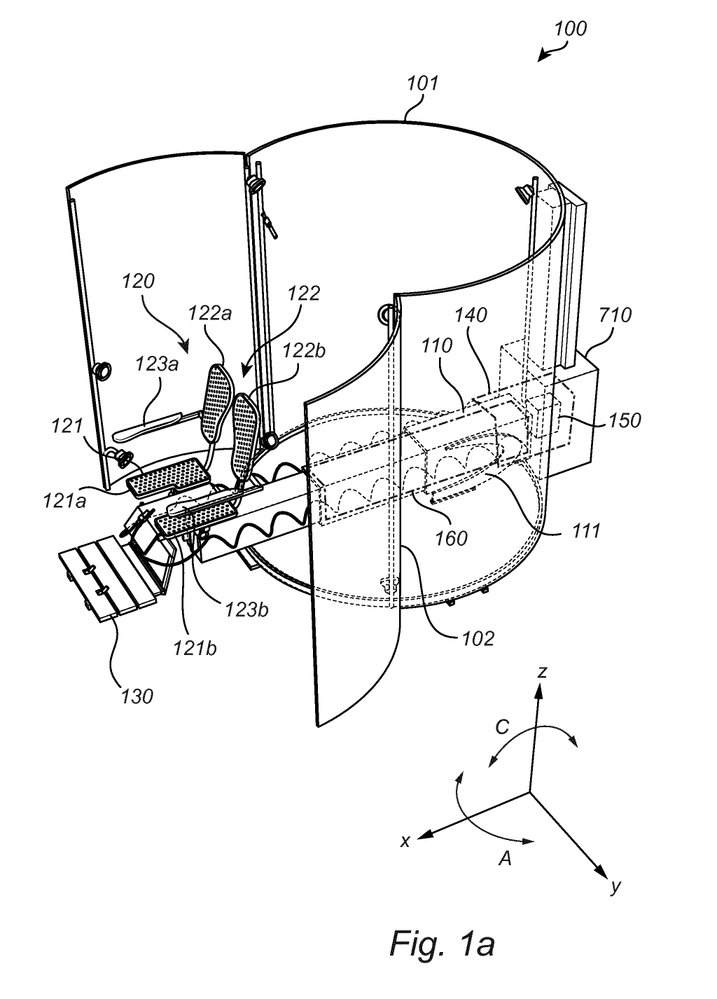

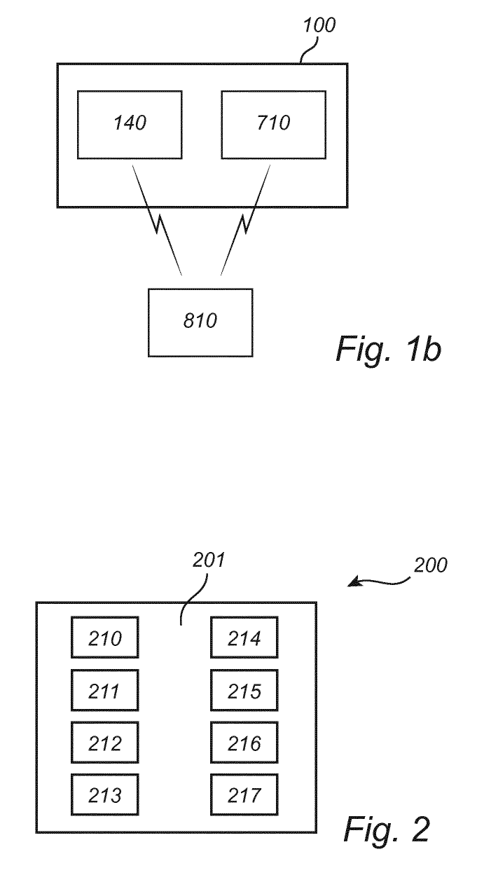

FIG. 1a shows a schematic illustration of a bathing aid 100. The bathing aid 100 comprises a bathing enclosure 101, which in FIG. 1a is exemplified as a (shower) cabin having the shape of a cylinder with an open top. Alternatively, the bathing enclosure 101 may be a cabinet, cubicle, booth, (bath) tub, or the like. The bathing enclosure 101 may comprise an at least partially transparent material, e.g. plexiglass, glass, plastics, or the like. In case of a substantially round bathing enclosure 101, as shown in FIG. 1, the diameter of the bathing enclosure 101 may be approximately 1000-1400 mm, preferably about 1200 mm. The bathing enclosure 101 comprises a side wall 102 which is openable and closable, and it will be appreciated that the side wall 102 may be opened or closed manually or automatically. The side wall 102 may furthermore comprise one or more sensors for sensing if the side wall 102 is correctly closed.

According to FIG. 1a, the bathing aid 100 further comprises a telescopic element 110, wherein a base portion 111 of the telescopic element 110 is fastened to the floor of the bathing aid 100. The telescopic element 110 is extendable and retractable along a horizontal axis x, indicated in the disclosed Cartesian coordinate system. The telescopic element 110 in FIG. 1 a is able to become longer (extended) or shorter (retracted) by sections which slide inside one another. However, it should be noted that other realizations of the telescopic element 110 may be feasible. In FIG. 1a, the telescopic element 110 is positioned in its extended position for a convenient access to the seat for a person before the showering and/or bathing or for a release of the person after the showering and/or bathing. It will be appreciated that the telescopic element 110 in its extended position is constructed to support a load of approximately 250 kg. The telescopic element 110 may furthermore be provided with a water tight cover.

The bathing aid 100 further comprises a seat 120 for supporting a person, wherein the seat 120 is arranged on (fastened to) the telescopic element 110. The seat 120 comprises a seat portion 121 to support a person in the seated position, a back rest 122 arranged substantially perpendicular to the seat portion 121 and two armrests 123a,b arranged alongside the seat portion 121.

In FIG. 1a, the seat portion 121 comprises two separated parts 121a,b arranged in parallel, thereby defining a space between them. The back rest 122 also comprises two parts 122a, b arranged in parallel such that a space is defined between them. The seat 120 further comprises a footrest 130 arranged below the seat portion 121, wherein the surface of the footrest 130 is substantially parallel with the surface of the seat portion 121. The footrest 130 may furthermore comprise one or more legs (not shown) protruding from the footrest 130 downwards, such that they are arranged to come into contact with the floor inside or outside the bathing enclosure 101. The footrest 130 may be configured to retract automatically to a position under the seat 120 when the seat 120 is in its retracted position. Analogously, the footrest 130 may be configured to extend automatically from the position under the seat 120 when the seat 120 is in its extended position.

The bathing aid 100 further comprises a schematically indicated actuation system 140 coupled to the telescopic element 110 and the seat 120. The actuation system 140, which is configured to move the telescopic element 110 and, consequently, also the seat 120 arranged on the telescopic element 110, comprises a power system 150 and a drive system 160. The power system 150, which may comprise one or more electronic cards (printed circuit cards), software, etc., is provided in a housing arranged on the side wall 102 of the bathing aid 100 on the outside of the bathing enclosure 101. The drive system 160, which may comprise one or more motor arrangements, couplings, gears, etc., is arranged at least partly within the telescopic element 110. The power system 150 and the drive system 160, as well as the connections between them, are hereby sealed from water. It will be appreciated that further details of the power system 150 and drive system 160 of the bathing aid 100, as well as the coupling between the two, is omitted, since such details are well known to the skilled person.

The actuation system 140 of the bathing aid 100 is configured to move the seat 120, which is arranged on the telescopic element 110, along the horizontal axis x between a retracted position of the seat 120 within the bathing enclosure 101 and an extended position of the seat 120 outside the bathing enclosure 101. Analogously, the actuation system 140 of the bathing aid 100 is configured to move the seat 120 arranged on the telescopic element 110 along the horizontal axis x between the extended position of the seat 120 outside the bathing enclosure 101 to the retracted position of the seat 120 inside the bathing enclosure 101. The time for extending the telescopic element 110 from the retracted position to the extended position (or vice versa) is approximately 30-40 seconds. Hence, the actuation system 140 is configured to extend (retract) the telescopic element relatively slowly, which is beneficial for safety reasons for a person sitting on the seat 120.

The actuation system 140 of the bathing aid 100, in the extended position of the seat 120, may be configured to rotate the seat 120 in a direction A in a horizontal plane, i.e. the x-y plane. For example, the actuation system 140 may be configured to rotate the seat approximately +90° to −90°, such as +45° to −45° in the direction A in the horizontal plane x-y. Furthermore, the actuation system 140 of the bathing aid 100, in the extended position of the seat 120, may be configured to tilt the seat 120 in the direction C with respect to a vertical axis z in the Cartesian coordinate system. For example, the actuation system 140 may be configured to tilt the seat forwards approximately 0-45°, such as 0-30°, in the direction C. Furthermore, the actuation system 140 may be configured to tilt the seat backwards approximately 0-25°, such as 0-15°, in the direction C. It will be appreciated that the seat in its initial positioning may be inclined (tilted) backwards, e.g.0-15°, to ensure a safe positioning of the person on the seat.

In FIG. 1a, the actuation system 140 of the bathing aid 100 may be configured to move the seat 120, in its extended position, along the vertical axis z in the Cartesian coordinate system. In other words, the actuation system 140 may be configured to adjust the height of the seat 120. For example the height of the seat portion 121 of the seat 120 may be set to approximately 35-60 cm, such as 42-52 cm, above the floor level. The bathing aid 100 in FIG. 1a further comprises a schematically indicated water supply system 710 for a supply of water to the bathing enclosure 101.

FIG. 1b shows a schematic illustration of a control system 810, according to the present invention, for a bathing aid 100 as exemplified in FIG. 1a. The control system 810 is configured for communicative coupling to the actuation system 140 and to the water supply system 710 of the bathing aid 100 as exemplified. The control system 810 may be coupled by wire or wirelessly to the actuation system 140 and to the water supply system 710. The control system 810 is configured to control a movement of the seat 120 of the bathing aid 100, via the actuation system 140. Furthermore, the control system 810 is configured to control a supply of water to the bathing enclosure 101, via the water supply system 710. It will be appreciated that the control system 810 may be automatically or manually operable. The control system 810 for the bathing aid 100 hereby provides a conveniently operable system for a person intending to take a shower and/or a bath by using a bathing aid 100 as exemplified, as the control system 810 allows for a convenient control of the seat movement of the bathing aid as well as a control of the water supply of the bathing aid.

FIG. 2 shows a schematic illustration of a control unit 200 of a control system according to an embodiment of the present invention. The control unit 200 may be arrangeable on the seat 120 of the bathing aid 100 as exemplified in FIG. 1a, and may be configured to be manually operable by a person sitting on the seat 120. The control unit 200 is exemplified as a unit comprising an area 201 indicating a plurality of control areas 210-217. It will be appreciated that the control areas 210-217 may comprise substantially any kind of element for manual control, such as touch screens, knobs, buttons, switches, etc. The area 201 as exemplified comprises the control areas “seat forwards” 210, “seat backwards” 211, “rotate/tilt seat” 212, “water on” 213, “water off” 214, “cleaning product on” 215, “cleaning product off” 216, and “cleaning program” 217. However, it will be appreciated that the control unit 200 may comprise more or fewer control areas than those indicated above for controlling the movement of the seat 120 and/or for controlling the supply of water to the bathing enclosure. A control of the movement of the seat 120 may be exemplified as follows: by pressing the control area “seat forwards” 210, the control system 810 may be configured to control the movement of the seat 120 on the telescopic element 110 along the horizontal axis x between a retracted position of the seat 120 within the bathing enclosure 101 and an extended position of the seat 120 outside the bathing enclosure 101. Analogously, by pressing the control area “seat backwards” 211, the control system 810 may be configured to control the movement of the seat 120 on the telescopic element 110 along the horizontal axis x between an extended position of the seat 120 outside the bathing enclosure 101 and a retracted position of the seat 120 inside the bathing enclosure 101. Furthermore, by pressing the control area(s) “water on” 213, “water off” 214, “cleaning product on” 215, “cleaning product off” 216 and/or “cleaning program” 217, the control system may be configured to control a supply of water and/or cleaning product to the bathing enclosure accordingly.

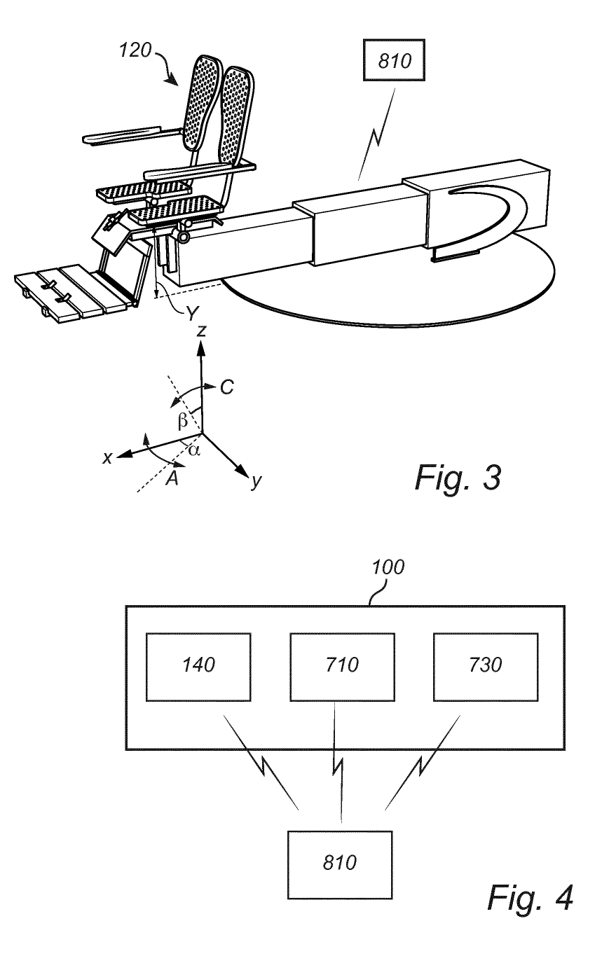

FIG. 3 shows a schematic illustration of a movement of the seat 120 which the control system 810 of the present invention is configured to control. The communicative coupling between the control system 810 and the actuation system (not shown) of the bathing aid may comprise a wired or wireless coupling. The control system 810 is only schematically indicated, and may be arranged at substantially any position inside our outside the bathing aid. FIG. 3 shows the seat 120 in its extended position, in which the control system 810 furthermore may be configured to control a rotation and/or tilting of the seat 120. For example, the control system 810 may be configured to control a rotation of the seat 120 to an angle α in the direction A in the horizontal x-y plane in the Cartesian coordinate system. Furthermore, the control system 810 may be configured to control a tilting of the seat 120 to an angle β in the direction C with respect to the vertical axis z. Furthermore, the control system 810 may be configured to control a raising (or lowering) of the seat 120 to a height y.

FIG. 4 shows a schematic illustration of a control system 810, according to an embodiment of the present invention, for a bathing aid 100 as exemplified in FIG. 1 a which furthermore comprises a product supply system 710. In the present embodiment, the control system 810 is configured for communicative coupling (by wire or wirelessly) to the actuation system 140, to the water supply system 710 and to the product supply system 730 of the bathing aid 100 as exemplified. The control system 810 is hereby configured to control the movement of the seat of the bathing aid, as well as being configured to control a supply of water and/or cleaning product to the bathing enclosure of the bathing aid. The control system 810 of the present embodiment may be manually or automatically operable. Furthermore, the control system may be configured to control the supply of water and/or cleaning product according to a predetermined cleaning program. For example, the predetermined cleaning program may include a supply of water and/or cleaning product wherein the amount, flow and/or temperature of the water and/or cleaning product is set in advance. For example, the control system may be configured to control a supply of water and/or cleaning product to the bathing enclosure according to a predetermined cleaning program such that a person sitting on the seat of the bathing aid may in a first stage of the cleaning program be showered (washed, sprayed) with water. Then, in a second stage of the cleaning program, the person may accordingly be showered (washed, sprayed) with a (body) cleaning product (e.g. soap). Then, in a third stage of the cleaning program, the person may again be showered with water. The control system 810 may alternatively be manually operable by the person using and/or intending to use the bathing aid, or be operable by any other person, such as an assistant, on the outside of the bathing enclosure.

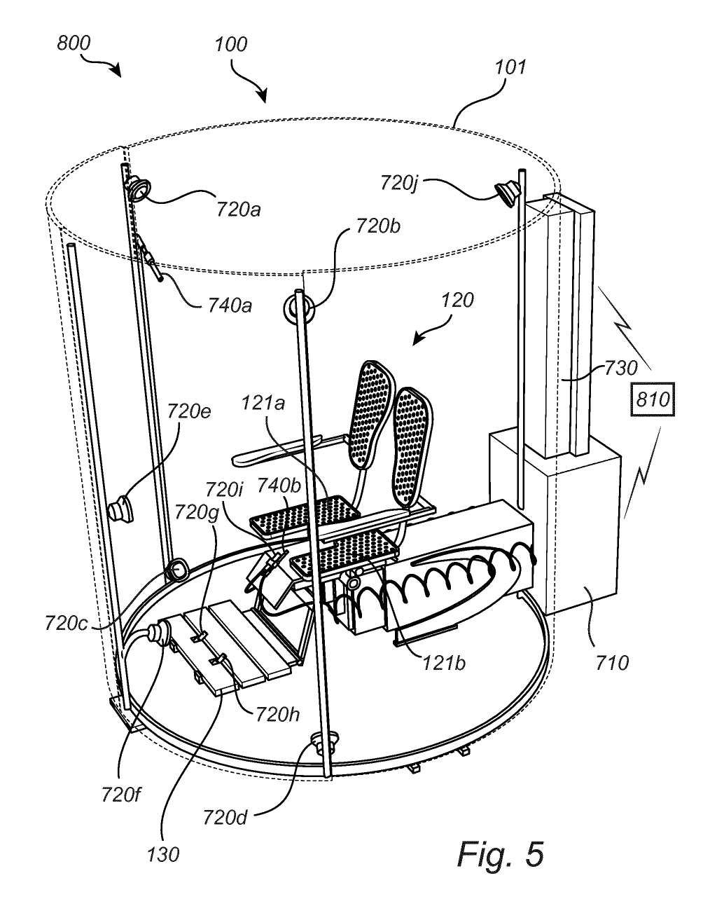

FIG. 5 shows a schematic illustration of a bathing system 800 according to an embodiment of the present invention. The bathing system 800 comprises a bathing aid 100 as previously described. Furthermore, the bathing aid 100 comprises a schematically indicated water supply system 710 for a supply of water to the bathing enclosure 101. Moreover, the bathing system 800 comprises a schematically indicated control system 810 as previously described, wherein the control system is configured for communicative coupling to the water supply system, and wherein the control system is configured to control a supply of water to the bathing enclosure. It will be appreciated that the bathing system 800 may be constructed or designed as a shower, wherein the supplied water may flow out through a floor drain arranged in the bathing enclosure 101. Alternatively, the bathing system 800 may be constructed or designed as a bath, wherein the supplied water may fill up the bathing enclosure 101 to a desired and/or predetermined water level. It will be appreciated that the water supply system 710 may comprise a water source such as a tap of a bathtub, shower, wash basin, or the like, which may be provided in the (bath) room where the bathing aid 100 is arranged. The water supply system 710 may further comprise one or more conduit(s), pump(s), etc., for a supply of water to the bathing enclosure 101. It should be noted that a more detailed description of the arrangement of the water supply system 710 is omitted.

The bathing system 800 in FIG. 5 further comprises a plurality of water nozzles 720 which are arranged within the bathing enclosure 101. The control system 810 is configured to control the supply of water to the water nozzles 720. The water nozzles 720 may be arranged/configured to spray water on a person sitting on the seat 120 of the bathing aid 100 for the purpose of cleaning said person. In the bathing system 800 as exemplified, there are ten water nozzles 720a-i arranged within the bathing enclosure 101. Water nozzles 720a and 720b are arranged on the front left and right hand side, respectively, of the bathing enclosure 101 and at relatively high positions with respect to the bathing enclosure 101 such that they are arranged to spray water obliquely downwards towards on a person sitting on the seat 120. For example, the water nozzles 720a and 720b may be arranged to spray water on the chest and/or torso of a person sitting on the seat 120. Accordingly, water nozzles 720c and 720d are arranged on the front left and right hand side, respectively, of the bathing enclosure 101 and at relatively low positions with respect to the bathing enclosure 101 such that they are arranged to spray water obliquely upwards towards on a person sitting on the seat 120. Water nozzles 720e and 720f are arranged in a vertical sequence on the front side of the bathing enclosure 101 such that they are arranged to spray water on the torso, thighs, legs and/or feet of a person sitting on the seat 120. Water nozzles 720g and 720h are arranged on the footrest 130 of the seat 120 such that they are arranged to spray water on the foot soles of a person sitting on the seat 120. Water nozzle 720i is arranged in (or in a vicinity of) the space defined by the two separated parts 121a,b of the seat 120. Water nozzle 720i is hereby arranged and/or configured to spray water obliquely upwards towards a genital, perianal and/or intergluteal area of a person sitting on the seat 120. It will be appreciated that water nozzle 720i may be of special importance for washing/cleaning the lower abdomen of women, as water from the water nozzle 720i may be sprayed in a direction from the vaginal area towards the perianal or intergluteal area. Water nozzle 720j is arranged on the back side of the bathing enclosure 101 such that it is arranged to spray water on the back of a person sitting on the seat 120. The bathing system 800 may further comprise a manually operable shower head (not shown) arranged within the bathing enclosure 101 for a convenient shower operation, if desired and/or needed, by a person sitting on the seat 120.

At least one of the water nozzles 720a-i may be configured to spray water in an area of the bathing enclosure 101 under the seat 120. As the seat 120 comprises two separated parts 121 a,b arranged in parallel and defining a space between them, the seat 120 may function as a toilet seat, whereby excrements such as faeces and/or urine may fall through the space of the seat 120 when a person is sitting on the seat 120. One or more water nozzles 720a-i may furthermore be configured to spray water in an area under the seat 120 in which excrements of the person may be present, such that this area may be cleaned.

In FIG. 5, the bathing system 800 further comprises product supply system 730 for a supply of a cleaning product to the bathing enclosure 101. The control system 810 is configured for communicative coupling to the product supply system 730 and is configured to control a supply of the cleaning product to the bathing enclosure 101. It will be appreciated that the cleaning product may relate to a body cleaning product such as soap, shampoo, etc., or may alternatively relate to a detergent or cleaning agent. The product supply system 730, which is arranged separately from the water supply system 710, comprises a container in which the cleaning product is stored. The product supply system 730 may further comprise one or more conduit(s), coupling(s), pump(s), etc., for a supply of cleaning product to the bathing enclosure 101. The product supply system 730 further comprises a plurality of cleaning product nozzles 740 which are arranged within the bathing enclosure 101. The control system 810 is configured to control the supply of cleaning product to the cleaning product nozzle(s) 740. The cleaning product nozzles 740 may be arranged to spray a body cleaning product (e.g. soap, shampoo, etc.) from the container on a person sitting on the seat 120 of the bathing aid 100 for the purpose of cleaning said person. Alternatively, one or more cleaning product nozzles 720a-i may be configured to spray a cleaning product (e.g. detergent, cleaning agent) in an area under the seat 120 in which excrements of the person may be present, such that this area may be cleaned.

In the bathing system 800 as exemplified in FIG. 5, there are two cleaning product nozzles 740a and 740b arranged within the bathing enclosure 101. Cleaning product nozzle 740a is arranged on the front side of the bathing enclosure 101 and at a relatively high position with respect to the bathing enclosure 101. The cleaning product nozzle 740a is hereby particularly suited to spray a body cleaning product obliquely downwards towards on a person sitting on the seat 120. For example, the cleaning product nozzle 740a may be configured to spray a body cleaning product on the chest and/or torso of a person sitting on the seat 120. Cleaning product nozzle 740b is arranged in (or in a vicinity of) the space defined by the two separated parts 121a,b of the seat 120. Cleaning product nozzle 740b is hereby arranged to spray a body cleaning product obliquely upwards towards a genital, perianal and/or intergluteal area of a person sitting on the seat 120. It will be appreciated that one or more of the water nozzles 720a-j and the cleaning product nozzles 740a-b may be adjustable with respect to its angle of inclination. Furthermore, the water nozzles 720a-j and the cleaning product nozzles 740a-b may comprise a bayonet coupling. The pressure in the water nozzles 720a-j and the cleaning product nozzles 740a-b is approximately 4-6 bar.

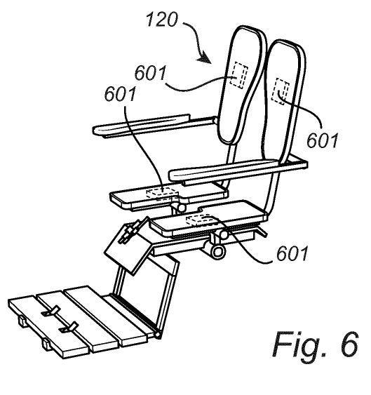

In FIG. 6, the seat 120 of the bathing aid comprises a plurality of weight sensors 601 of the control system for sensing the weight of a person sitting on the seat 120. Here, the weight sensors 601 of the control system have been arranged on the seat 120 such that the weight sensors 601 may determine the distribution of the weight of the person sitting on the seat 120. It will be appreciated that the number, size and/or placement of the weight sensors 601 may vary. The control system may hereby be configured to control a movement of the seat 120 and configured to control a supply of water to the bathing enclosure as a function of the weight sensed by the at least one weight sensor. For example, the control system may be configured to determine if a person sits correctly or incorrectly on the seat 120. In case the control system determines that a person sits correctly on the seat 120 it may be configured to control the movement of the seat 120 and be configured to control a supply of water to the bathing enclosure accordingly. In case the control system determines that a person sits incorrectly on the seat 120, it may be configured to stop the movement of the seat 120 due to safety reasons.

Even though the invention has been described with reference to specific exemplifying embodiments thereof, many different alterations, modifications and the like will become apparent to those skilled in the art after studying this description. The described embodiments are therefore not intended to limit the scope of this invention. For example, the size and/or shape of one or more of the part, portions and/or elements of the control system 810 and/or bathing system 800 such as the bathing enclosure 101, the seat 120, the telescopic element 110, etc. may be different that that shown or indicated. Furthermore, the number, positioning of one or more of the part, portions and/or elements of the bathing system 800 such as the water nozzles 710 and/or the cleaning product nozzles 720 may be different than that shown.

1. A control system for a bathing aid, wherein the bathing aid comprises:
a bathing enclosure;
a telescopic element arranged at least partially within the bathing enclosure, wherein the telescopic element is configured to be extendable and retractable along a horizontal axis;
a seat configured to supporting a person, wherein the seat is being arranged on the telescopic element;
an actuation system coupled to the telescopic element and the seat, wherein the actuation system is configured to move the seat on the telescopic element along the horizontal axis between a retracted position of the seat that is within the bathing enclosure and an extended position of the seat that is outside the bathing enclosure; and
a water supply system configured to provide a supply of water to the bathing enclosure,
wherein the control system is configured for communicative coupling to the actuation system and to the water supply system, and wherein the control system is configured to control a movement of the seat and is configured to control the supply of water to the bathing enclosure.

2. The control system of claim 1, wherein the control system comprises at least one control unit, and the control unit is arrangeable on the seat and is configured to be manually operable by a person sitting on the seat.

3. The control system of claim 1, wherein the water supply system comprises at least one water nozzle arranged within the bathing enclosure and is configured to spray water, and the control system is configured to control the supply of water to the at least one water nozzle.

4. The control system of claim 1, wherein the control system is configured to control the supply of water to the bathing enclosure based on at least one of a predetermined cleaning program or a manual operation.

5. The control system of claim 1, wherein the bathing aid further comprises a product supply system configured to provide a supply of at least one cleaning product to the bathing enclosure, and the control system is configured for communicative coupling to the product supply system and is configured to control the supply of the at least one cleaning product to the bathing enclosure.

6. The control system of claim 5, wherein the product supply system comprises at least one cleaning product nozzle arranged within the bathing enclosure and is configured to spray a cleaning product, and the control system is configured to control the supply of the cleaning product to the at least one cleaning product nozzle.

7. The control system of claim 5, wherein the control system is configured to control the supply of the cleaning product to the bathing enclosure to based on at least one of a predetermined cleaning program or a manual operation.

8. A bathing system comprising:
a bathing aid comprising:
a bathing enclosure;
a telescopic element arranged at least partially within the bathing enclosure, wherein the telescopic element is configured to be extendable and retractable along a horizontal axis;
a seat configured to supporting a person, wherein the seat is arranged on the telescopic element;
an actuation system coupled to the telescopic element and the seat, wherein the actuation system is configured to move the seat on the telescopic element along the horizontal axis between a retracted position of the seat within the bathing enclosure and an extended position of the seat outside the bathing enclosure, and
a water supply system configured to provide a supply of water to the bathing enclosure,
wherein the bathing system further comprises a control system, wherein the control system is configured for communicative coupling to the actuation system and to the water supply system and is configured to control a movement of the seat and is configured to control the supply of water to the bathing enclosure.

9. The bathing system of claim 8, further comprising at least one water nozzle arranged within the bathing enclosure, and the water nozzle is configured to spray water.

10. The bathing system of claim 9, wherein the seat comprises two separated parts arranged in parallel and defines a space between the two separated parts, wherein at least one the water nozzle is configured to spray the water through the space on the person sitting on the seat.

11. The bathing system of claim 9, wherein the seat comprises two separated parts arranged in parallel and defines a space between the two separated parts, wherein the water nozzle is configured to spray the water in an area of the bathing enclosure under the space.

12. The bathing system of claim 8, further comprising a product supply system configured to provide a supply of at least one cleaning product to the bathing enclosure, wherein the product supply system comprises at least one cleaning product nozzle arranged within the bathing enclosure and is configured to spray the cleaning product.

13. The bathing system of claim 12, wherein the seat comprises two separated parts arranged in parallel and defines a space between the two separated parts, wherein at least one of the cleaning product nozzle is configured to spray the cleaning product through the space on a person sitting on the seat.

14. The bathing system of claim 12, wherein the seat comprises two separated parts arranged in parallel and defines a space between the two separated parts, wherein at least one of the cleaning product nozzle is configured to spray the cleaning product in an area of the bathing enclosure under the space.

15. (canceled)

16. A method of bathing a person in a bathing system comprising:
controlling a movement of a seat via an actuation system, wherein the bating system comprising:
a bathing enclosure;
a telescopic element arranged at least partially within the bathing enclosure, wherein the telescopic element is configured to be extendable and retractable along a horizontal axis;
the seat configured to support a person, wherein the seat is arranged on the telescopic element;
the actuation system coupled to the telescopic element and the seat, wherein the actuation system is configured to move the seat on the telescopic element along the horizontal axis between a retracted position of the seat within the bathing enclosure and an extended position of the seat outside the bathing enclosure; and
a water supply system configured to provide a supply of water to the bathing enclosure; and
controlling a supply of water to the bathing enclosure via the water supply system.

17. The bathing system of claim 8, wherein the control system comprises at least one control unit, and the control unit is arrangeable on the seat and is configured to be manually operable by a person sitting on the seat.

18. The bathing system of claim 9, wherein the control system is configured to control the water supply system.

19. The method of claim 16, wherein controlling the movement of a seat comprises:
extending the seat along the horizontal axis within the bathing enclosure to the outside of the bathing enclosure; and
retracting the seat along the horizontal axis from the outside of the bathing enclosure into the bathing enclosure.

20. The method of claim 16, wherein controlling the movement of a seat comprises:
rotating the seat to an angle in a horizontal plane;
tilting the seat to an angle in a vertical direction; and
changing a height location of the seat along the vertical direction.

21. The method of claim 16, wherein controlling the supply of water to the bathing enclosure comprises:
controlling an amount of water, water distribution, or water temperature; and
spraying the supply of water via at least one water nozzle based on at least one of a manual operation or a predetermined program.
